(19) United States
(12) Patent Application Publication
(10) Pub. No.: US 2008/0075235 A1
(43) Pub. Date: Mar. 27, 2008

(54) ATM emergency database system for response to duress transactions

(76) Inventor: Ronald K. Russikoff, Philadelphia, PA (US)

Correspondence Address: Armand M. Vozzo, Jr., Esquire, 19 Short Road, Doylestown, PA, 18901, US

(21) Appl. No.: 11/903,273

(22) Filed: Sep. 22, 2007

Related U.S. Application Data
(60) Provisional application No. 60/846,503, filed on Sep. 23, 2006.

(51) Int. Cl. H04M 11/04

(52) U.S. Cl. 379/45

(57) ABSTRACT

A computerized database system and associated process are disclosed for expediting an emergency response to an alarm signal indicative of a duress transaction imposed upon an ATM customer at a particular ATM terminal site. The system comprises an emergency response database stored at a secure location accessible by a bank or other financial service institution hosting the ATM either directly or through a data communications network. The emergency response database is compiled containing coded data indicative of the bank host, the ATM terminal location and respective serial number, customer identification information, and contact information for the designated emergency monitoring center and the appropriate public safety answering point (PSAP) for the given ATM terminal location. The present system enables the bank host through its conventional network processor to identify the victimized ATM customer and the terminal site of the duress transaction upon receipt of the alarm signal and then further access the emergency response database to retrieve the designated emergency monitoring center and appropriate PSAP to contact in relation to the ATM location. The retrieved database information is then forwarded to the designated monitoring center and relayed to the proper PSAP to expedite the dispatch of the authorities to the particular ATM terminal site.

### CROSS-REFERENCE TO RELATED APPLICATION

This application is a continuation-in-part of Provisional Application Ser. No. 60/846,503 filed Sep. 23, 2006, 2006 for ATM Emergency Database System for Response to Duress Transactions.

### BACKGROUND OF THE INVENTION

The present invention relates to computerized financial transactions of the type conducted at remote terminals, referred to as automatic teller machines (ATMs), and more particularly to a computerized database system and associated process for expediting an emergency response to a discreet alarm signal initiated from a specific ATM location by an ATM customer making a transaction request under duress by using stored database information to direct the prompt dispatch of responsible personnel to the specific ATM location.

The recent proliferation of ATM installations throughout the United States has resulted in billions of ATM transactions being conducted annually. To protect ATMs against fraud and generally prevent unauthorized access to customer accounts by third parties using stolen or detected customer identification information, security systems have been devised for ATM use and incorporated within the associated electronic communications networks that encrypt and decrypt customer account information in transmissions between the ATM terminal and the data processing network used by the associated bank or other financial host in order to make deciphering difficult and any intercepted information unusable. As a result, ATM customer identification numbers and passwords, unless mistakenly disclosed or stolen, have been made reasonably secure and these prior art security measures have been generally effective in disrupting and preventing electronic fraud in the processing of normal transaction requests at ATMs.

These various data security measures have not, however, effectively helped with the growing problem of duress transactions forced upon an ATM customer at a remote terminal location and imposed under threat of physical harm. Typically in these duress transactions, the victimized ATM customer is accosted by a thief and forced to make cash withdrawal from the customer's account. To avoid immediate harm, the innocent ATM customer must choose to comply with the demands of the thief and proceed as normally as possible with the standard protocol for cash withdrawals. Failure by the ATM customer to follow a course other than the standard protocol, whether caused by panic confusion or done deliberately to reject the transaction request and deny the cash withdrawal, will likely place the ATM customer in immediate danger of retaliation. To better deal with these duress transaction requests, it is desirable that the ATM feature a security system designed to recognize the forced nature of the transaction and further trigger a distress signal to police or other monitoring authorities. This distress signal to the authorities can provide a prompt response to the ongoing criminal activity; however, the signal must be made discreetly and in as normal a protocol as possible in order to avoid recognition by the thief and an immediate retaliation against the ATM customer.

Various computerized ATM security systems have been devised and developed for the discreet identification of a duress transaction request and the consequent registration of a silent alarm signal with the authorities. Some of these prior art systems, such as U.S. Pat. No. 5,354,974 to Eisenberg and U.S. Pat. No. 5,731,575 to Zingher et al., provide for the generation of the silent alarm signal through the ATM customer's input of an assigned alternate emergency personal identification number (PIN) or personal distress code when the customer is requesting cash under duress. In the case of Eisenberg, a specific emergency code assigned to the customer needs to be remembered and entered, while in the case of Zingher et al., the personal distress code triggering the silent alarm is registered with the help of a programmed algorithmic function that facilitates recall of the distress code. In a more recent ATM security system disclosed in U.S. Pat. No. 6,871,288, a second level of verification for the ATM transaction is provided wherein the ATM customer is presented with a list of transaction acceptance passwords (TAPs) in a display after initial input and verification of the customer's PIN. The selection of the customer's currently assigned TAP then serves to verify the legitimacy of the transaction while the input of any of the others is intended to indicate that a duress transaction request is being made so that a discreet alarm may be initiated without the need to remember any specific emergency code in the dramatic stress of a duress transaction. While these and other prior art ATM security systems have provided satisfactory methodologies for the discreet recognition and signaling of an ongoing duress transaction, none appear to further assist the victimized customer in expediting an emergency response and prompt dispatch of authorized personnel to the specific ATM location where the duress transaction is in process.

### SUMMARY OF THE INVENTION

Accordingly, it is a general purpose and object of the present invention to provide an improved ATM security system and associated data processing method for facilitating an expedited response by police or other authorities to a discreet alarm signal initiated by an ATM customer being victimized in making a duress transaction request.

A more particular object of the present invention is to provide a computerized means and methodology for expediting an emergency response to a discreet alarm signal when initiated by an ATM customer in a duress transaction at a specific ATM terminal by routing informational data indicative of the transaction and its terminal location for the prompt dispatch of authorities to the terminal site.

Another object of the present invention is to provide a computerized data processing system and associated method for directing the dispatch of the most expeditious response to an ATM duress transaction by authorities most proximate to the terminal site of the transaction.

Still another object of the present invention is to provide a computerized data processing system for facilitating an emergency response to an ongoing ATM duress transaction that is capable of being integrated into existing ATM networks used to process normal transaction requests and further signal the occurrence of those made under duress.

A still further object of the present invention is to provide a safe and reliable computerized system for data processing that is capable of directing an effective response to an ATM duress transaction without risk of harm to the victimized ATM customer.

Briefly these and other objects of the present invention are accomplished by a computerized database system and associated process for expediting an emergency response to an alarm signal indicative of a duress transaction being made by an ATM customer at a particular ATM terminal site. The system comprises an emergency response database stored at a secure location accessible by a bank or other financial service institution hosting the ATM either directly or through a data communications network. The emergency response database is compiled containing coded data indicative of the bank host, the ATM terminal location and respective serial number, customer identification information, and contact information for the designated emergency monitoring center and the appropriate public safety answering point (PSAP) for the given ATM terminal location. The present system enables the bank host through its conventional network processor to identify the victimized ATM customer and the terminal site of the duress transaction upon receipt of the alarm signal and then further access the emergency response database to retrieve the designated emergency monitoring center and appropriate PSAP to contact in relation to the ATM location. The retrieved database information is then forwarded to the designated monitoring center and relayed to the proper PSAP to expedite the dispatch of the authorities to the particular ATM terminal site.

For a better understanding of these and other aspects of the present invention, reference should be made to the following detailed description taken in conjunction with the accompanying drawings in which like reference numerals and characters designate like parts throughout the figures thereof.

### BRIEF DESCRIPTION OF THE DRAWINGS

For a full understanding of the nature and object of the present invention, references in the detailed description of the preferred embodiment set forth below shall be made to the accompanying drawings in which:

FIG. 1 is a block diagram of the computerized database system in accordance with the present invention;

FIG. 2 illustrates a sample listing of emergency response data collected and employed in the database system according to the present invention; and

FIG. 3 is a flow chart illustrating the operational process of the present emergency response database system shown in FIG. 1.

### DETAILED DESCRIPTION OF THE INVENTION

The following is a detailed description of the preferred embodiment of the present invention and the best presently contemplated mode of its production and practice. This description is further made for the purpose of illustrating the general principles of the invention but should not be taken in a limiting sense, the scope of the invention being best determined by reference to the appended claims.

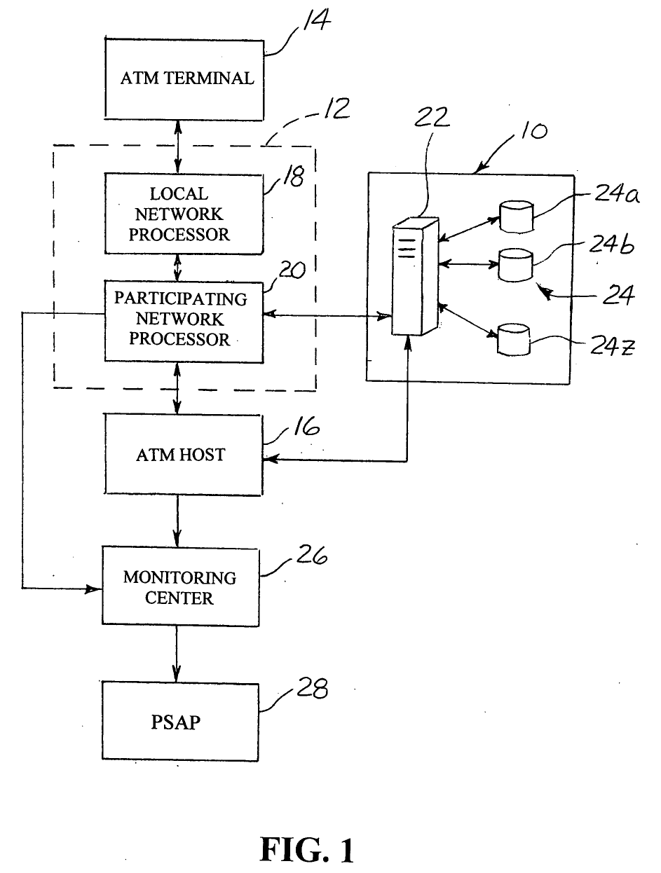

Referring now to FIG. 1, an ATM emergency response database system 10 according to the present invention is shown linked to an established data communications network 12 that incorporates state-of-the art electronic technology designed to receive, process and transmit transactional data required for verification, acceptance and execution of automated banking and other financial transactions requested by an authorized customer. These automated transactions are commonly made in the banking and financial section at an ATM terminal 14 where the authorized customer of a host bank 16 or other financial institution hosting the terminal may complete any one of a number of selected transactions, including cash withdrawals on his or her account, after verification of proper authorization.

Each host bank 16 commonly has a multitude of ATM terminals 14 at various locations, all the terminals being linked together and operated effectively by the data communications network 12. The data communications network 12 further includes a local network processor 18 and a participating network processor 20. The local network processor 18 comprises established data processing electronics linked and adapted to receive transactional data from the ATM terminal 14, such transactional data being initially collected at the ATM terminal from the ATM customer and then encrypted at the terminal before being sent to the local network processor as an encrypted data message. Typical data inputted and collected at the ATM terminal 14 in the case of a normal transaction request, that being an ATM transaction request not made under duress, includes customer PIN and any password or other form of verification normally required by the terminal host, the type or nature of the transaction requested and the amount of the transaction. In the case of a duress transaction request, additional customer information or coded data may be inputted as required by an established ATM security system, such as those of the prior art described above, that is installed and incorporated within the ATM terminal 14 for discreet recognition of the duress transaction request and generation of a silent alarm signal intended to trigger an emergency response. In accordance with standard protocols and established software for their execution, the local network processor 18 first decrypts the encrypted data message received from the ATM terminal 14 to determine the proper participating network for the customer's normal transaction request and then re-encrypts the data message, including any data indicative of a duress transaction request for transmittal to the participating network processor 20 for verification.

The participating network processor 20 determined to serve the instant ATM terminal 14 and others of the host bank 16 is linked to receive the encrypted transactional data message from the local network processor 18 and using established software, decrypts the message to determine what the instant host bank requires in the form of verification to process the transaction request made at the ATM terminal under normal conditions and absent duress. Upon such verification by the host bank 16 in the case of a normal transaction request, the host bank validates the transaction request and sends a corresponding verification message back to the participating network processor 20 for processing. For the normal transaction request, the participating network processor 20 encrypts the verification message from the host bank 16 and sends the encrypted message to the local network processor 18 which in turn decrypts the message and in so doing, determines the instant ATM terminal 14 for notification and sends authorization for the execution of the transaction request to the ATM terminal.

In accordance with the present invention, at the same time the data communications network 12 is operating under normal protocols described above to seek verification and acceptance of the transaction request from the host bank 16, the network is further linked and adapted to receive an alarm signal message from the ATM terminal 14 indicative of a transaction request being made under duress. The alarm signal message may be distinct from the encrypted transactional data message sent from the ATM terminal 14 for normal transaction requests or may be combined therewith, the alarm signal component in the latter case being an encrypted portion of the transactional data message received by the local network processor 18. Regardless of its distinct or combined form, the alarm signal message is initially decrypted by the local network processor 18 and then directed along with the normal transaction data message to the corresponding participating network processor 20 determined to be serving the ATM operations for the host bank 16 of the instant ATM terminal 14 from which the alarm signal has been generated. Upon recognition of the alarm signal message received from the local network processor 18 and verification of its validity with the host bank 16, the participating network processor 20 is directed under the control of established software to access the ATM emergency response database system 10 of the present invention for selective retrieval and processing of stored data information intended to expedite a response to the terminal site of the ongoing duress transaction. This initialization of access to the present ATM emergency response database system 10 occurs at the same time the participating network processor 20 is seeking from the bank host 16 the verification message for validation and acceptance of the transaction request, even though made under duress, in order to preserve the discreet nature of the intended emergency response and not cause any immediate harm to the victimized ATM customer.

The present emergency response system 10 includes a database server 22 of conventional design and use for electronic access and retrieval of data and an emergency response database 24 comprising a plurality of relational databases 24a, 24b, . . . 24z each compiled to contain a categorized record of informational data useful in facilitating the dispatch of an emergency response to a duress transaction being imposed upon an ATM customer at a particular terminal site. The relational database structures 24a, 24b, . . . 24z are conventional computer storage units typically known and used in the field of information technology and are compatible for operation with the database server 22. While the server structure 22 is depicted as a single unit of hardware, it should be understood and apparent to those skilled in the art that other hardware and software configurations may be utilized in effecting the access and retrieval of the emergency response database 24 in accordance with the present invention.

In accordance with the present invention, groups of related informational data are compiled and stored within the respective database structures 24a, 24b, . . . 24z of the emergency response database 24. Each of the data groups is categorized and intended to contain information data relevant to the identification and location of groups of ATM terminals and their respective bank hosts, any associated customer accounts and the identification of those potential customer-users of the ATMs, as well as the location and contact particulars for the group of known monitoring centers employed generally within the emergency 9-1-1 system to field, screen and route 9-1-1 or other alert calls for emergency dispatch, and the group of known public safety answering points (PSAP) further employed within the 9-1-1 system to dispatch police or other authorities upon receipt of alert calls from an associated monitoring center. It should be noted that generally all home 9-1-1 alert calls and bank silent alarms are currently being required to go through designated monitoring centers for screening before being relayed to the proper PSAP to reduce the number of false alarms in the dispatch of authorities. Accordingly, the present emergency response database system 10 and its associated emergency response database 24 are structured and intended to operate within current 9-1-1 emergency dispatch protocols.

Representative examples of the type of informational data to be compiled and stored within the database structures 24a, 24b, . . . 24z of the emergency response database 24 are:

a. Names, addresses and telephone numbers of ATM host banks and other financial institutions;

b. Addresses and precise locations of ATM terminal sites in longitudinal and latitudinal coordinates;

c. Serial numbers of the ATMs;

d. Names and physical descriptions (sex, height and weight) of customers;

e. Other means for customer identification, such as driver's registration;

f Locations and dedicated alarm line telephone numbers of monitoring centers within a geographical area; and

g. Locations and dedicated alarm line telephone numbers of PSAPs within established PSAP jurisdictional boundaries of any geographical area.

It should be noted and understood, therefore, that the informational data contained in the emergency response database 24 and extracted upon the requested inquiry of the participating network processor 20 will provide important information and serve to identify:
i. the precise ATM location that is seeking emergency response;
ii. the identify of the ATM customer who is being victimized;
iii. the monitoring center designated to contact in the area of the particular ATM site;
iv. the proper PSAP proximate to the ATM site; and
V. the correct alarm line for contacting the proper PSAP.

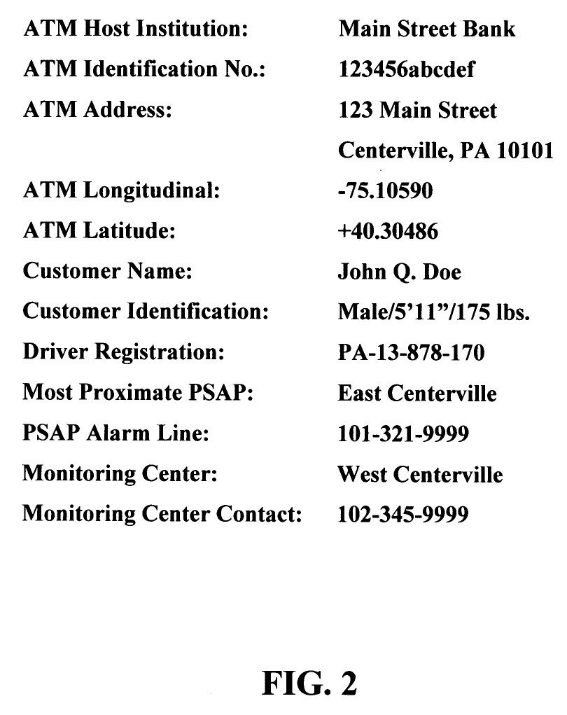

The participating network processor 20 initiates access to the emergency response database 24 via the database server 22 and based upon information received in the transactional data message regarding the particular ATM signaling the duress alarm, its bank host and the customer account involved in the duress transaction, the participating network processor issues a query and requests further informational data from the emergency response database regarding the exact location and specific address of the involved ATM, the complete identification with physical description of the involved customer, the appropriate monitoring call center designated for emergency response to the involved ATM site, and the most proximate PSAP to contact in relation to the involved ATM site. The requested informational data contained and found within respective database structures 24a, 24b, . . . 24z of the emergency response database 24 is extracted therefrom using established software and provided to the participating network processor 20 via the server 22 in response to the emergency query. A sample listing of extracted informational data retrieved from the emergency response database 24 upon request by the participating network processor 20 is presented in FIG. 2.

Under the control of established software, the network processor 20 operates to process the extracted informational data received from the emergency response database 24 and immediately sends the processed emergency response data in the form of a message signal to the designated call monitoring center 26. The call monitoring center 26 is adapted to receive the data message signal from the network processor 20 and in accordance with the emergency response data contained therein, relays the data message to the indicated PSAP 28 most proximate to the instant ATM terminal 14 for immediate and informed dispatch of the police or other authorities to the particular terminal site of the duress transaction and the aid of the victimized ATM customer. It is preferred that the emergency response data message be relayed automatically from the designated monitoring center 26 to the proper PSAP 28 using established electronic means of communications. It is also noted that, as shown in FIG. 1, the present emergency database system 10 may be further linked to the bank host 16 or other host financial institution associated with the instant ATM terminal 14 so that the host may have direct access to the emergency response database 24 via server 22 and thus be enabled to retrieve requested informational data from the database structures 24a, 24b, . . . 24z for host utilization in expediting the emergency response as an alternative or back-up to the network processor 20 in accordance with the present invention.

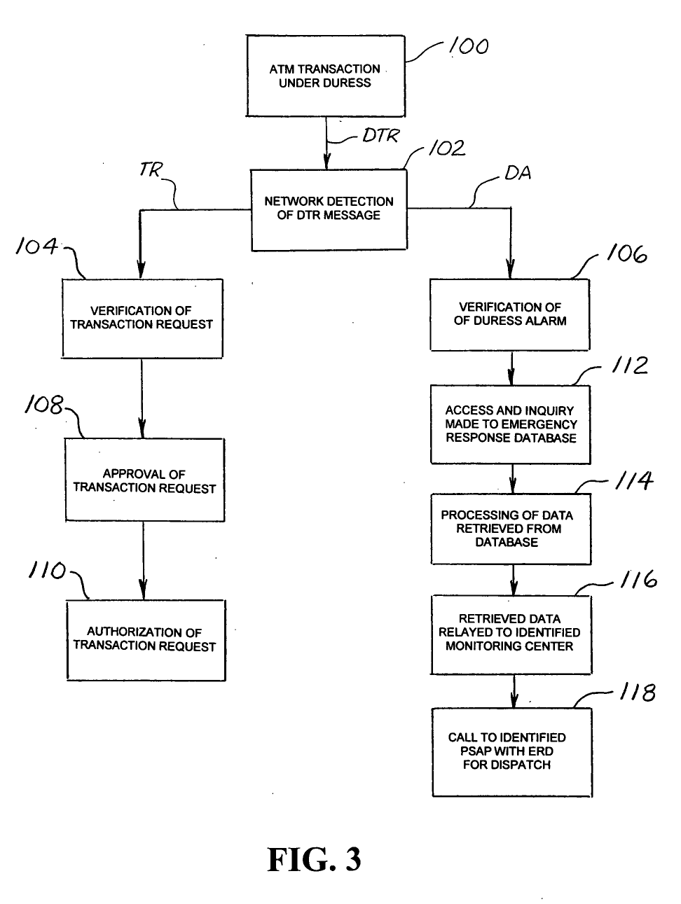

Referring now to FIG. 3 in conjunction with FIGS. 1 and 2, the associated method for facilitating an emergency response to a duress ATM transaction implemented in connection with the present emergency response database system 10 is initiated in step 100 by the generation of a duress transaction request (DTR) signal message from the instant ATM terminal 14. As described above, the DTR signal message will be triggered by the ATM customer using an established ATM security system that is installed at the terminal and designed to provide discreet recognition and signaling of an ongoing duress transaction. As those established ATM security systems are typically designed to allow a duress transaction request to be processed as entered, the DTR signal message will have a transaction request component TR as well as a duress alarm component DA intended to be processed concurrently. Detection of the DTR signal message and initiation of the concurrent processing of its transaction request and duress alarm components, TR and DA respectively, are then implemented by the data communications network 12 and its network processors 18 and 20 in step 102. In such case of concurrent processing, the transaction request component TR proceeds through sequential steps of verification 104, approval 108 and authorization 110 of the transaction request by means of the network processors 18 and 20 and their associated data message transmissions between the bank host 16 and ATM terminal 14. If there is no transaction request being made by the victimized customer and the duress signal is rather generated by means of an electronic switch or “panic” button at the terminal site, the duress signal so generated would still serve to initiate the present emergency response method without need for separate concurrent processing of a transaction request.

The duress alarm DA is initially processed by the network 12 to verify its validity in step 106. Upon such validation, the network 12 is made to access the ATM emergency response database 24 via server 22 and requests relevant informational data from the database in step 112 based upon the ATM terminal and customer initiating the duress alarm. The extracted informational data retrieved from the emergency response database 24 is processed in step 114 by the network processor 20 or the bank host 16, as the case may be, and the relevant information is gathered therefrom regarding the exact location of the ATM terminal 14, the identification and description of the ATM customer, the designated monitoring center 26 and its contact information, and the proper PSAP 28 indicated as most proximate to the terminal site. This relevant informational data retrieved from the emergency response database 24 is then relayed in step 116 to the designated monitoring center 26 which, in turn, forwards the emergency response data to the indicated PSAP in step 118 for the immediate and informed dispatch of authorities to the terminal site.

Therefore, it is apparent that the described invention provides an improved computerized system and associated data processing method for facilitating an expedited response by police or other authorities to a distress alarm signal triggered by an ATM customer being victimized at a terminal site in a duress transaction. More particularly, the present invention provides computerized means and methodology for expediting an emergency response directly to the site of an ATM duress transaction by relaying to the most appropriate PSAP an alarm signal along with informational data indicative of the terminal location and the customer affected for dispatch of authorities proximate to the terminal site. In addition, the present invention provides a computerized data processing system and associated method for directing the dispatch of the emergency response to authorities most proximate to the terminal site of the transaction. The described inventive system is further capable of being integrated into existing ATM network environments that process normal transaction requests and signal the occurrence of those made under duress, and operates in a discrete manner to expedite an effective response to an ATM duress transaction without risk of harm to the victimized ATM customer.

Obviously, other embodiments and modifications of the present invention will readily come to those of ordinary skill in the art having the benefit of the teachings presented in the foregoing description and drawings. Alternate conventional means as well as substitute systems that may be developed at a future time to perform the same function as the present described embodiment are therefore considered to be part of the present invention. For example, the emergency response database 24 is not limited as to its stored location and may be stored at and made accessible to an ATM terminal equipped with the data processing and communication technology needed to retrieve and transmit the emergency response informational data to the proper monitoring center 26 and PSAP 28. Likewise, the emergency response database 24 may be stored within the host bank 16, the network 12 or at a remote location accessible to each. Accordingly, it is understood that this invention is not limited to the particular embodiment described, but rather is intended to cover modifications within the spirit and scope of the present invention as expressed in the appended claims.

What is claimed is:

1. A system for facilitating an emergency dispatch response to an alarm signal indicative of an ATM transaction request being made under duress by a customer at one of a plurality of ATM terminal locations of a host institution, comprising:
data communications network means operatively linking the plurality of ATM terminal locations of the host institution and connected to receive the alarm signal for processing and verification thereof;
emergency response database means for electronically storing a plurality of separate data groups of information accessible to said data communications network means, each data group containing informational data regarding the host institution, the identity of ATM customers thereof, the identity and location of all ATM terminals of the host institution, the locations and contact particulars of known 9-1-1 emergency call monitoring centers within a local geographical area, and the locations and contact particulars of known public safety answering points (PSAP) most proximate to each of the respective ATM terminals of the host institution; and
server means operatively linked to said data communications network means for selectively retrieving relevant informational data from said emergency response database means based upon the alarm signal intended to identify the ATM customer and ATM terminal location of the host institution under duress and the most appropriate emergency call monitoring center and PSAP for effecting the emergency dispatch response.

2. The system according to claim 1, further comprising:
means for communicating the retrieved informational data relevant to the ATM customer and ATM terminal location under duress to the host institution; and
means for automatically relaying the retrieved informational data to the designated emergency call monitoring center and PSAP most appropriate to effect the emergency dispatch response.

3. The system according to claim 2, wherein said emergency response database means further comprises:
a plurality of relational database structures each compiled to contain a categorized record of informational data relevant to the identification and location of all ATM terminals and all ATM customers of the host institution potentially subject to a duress transaction and all emergency call monitoring centers and PSAPs available to dispatch a response thereto.

4. A method for expediting an emergency dispatch response to an ATM transaction request being made under duress by a customer at one of a plurality of ATM terminal locations of a host institution, comprising the steps of:
generating a discreet alarm signal indicative of the duress transaction request being made;
processing the alarm signal to validate its indication of the duress transaction being made;
accessing a stored emergency response database compiled of a plurality of separate data groups of information, each data group containing informational data regarding the host institution, the identity of ATM customers thereof, the identity and location of all ATM terminals of the host institution, the locations and contact particulars of known 9-1-1 emergency call monitoring centers within a local geographical area, and the locations and contact particulars of known public safety answering points (PSAP) most proximate to each of the respective ATM terminals of the host institution;
selectively retrieving relevant informational data from the data groups of the emergency response database intended to identify the ATM customer and ATM terminal location of the host institution under duress and the most appropriate emergency call monitoring center and PSAP for effecting the emergency dispatch response.

5. The method according to claim 4, further comprising:
communicating the retrieved informational data relevant to the ATM customer and ATM terminal location under duress to the host institution; and
relaying the retrieved informational data to the designated emergency call monitoring center and PSAP most appropriate to effect the emergency dispatch response.

6. In the operation of ATM terminals of a host institution having means for generating an alarm signal indicative of a duress transaction request being made by an ATM customer at a particular ATM terminal location, an improvement in providing an emergency response dispatch to the duress transaction, comprising the steps of:
after validating the alarm signal, accessing a stored database compiled of a plurality of separate data groups of information, each data group containing informational data regarding the host institution, the identity of ATM customers thereof, the identity and location of all ATM terminals of the host institution, the locations and contact particulars of known 9-1-1 emergency call monitoring centers within a local geographical area, and the locations and contact particulars of known public safety answering points (PSAP) most proximate to each of the respective ATM terminals of the host institution; and
selectively retrieving relevant informational data from the data groups of the stored database intended to identify the ATM customer and ATM terminal location of the host institution under duress and the most appropriate emergency call monitoring center and PSAP for effecting the emergency dispatch response.
